(19) United States
(12) Patent Application Publication
(10) Pub. No.: US 2015/0029401 A1
(43) Pub. Date: Jan. 29, 2015

(54) AV switching device control using a Zero Configuration Network protocol

(71) Applicant: Jason Meiners, Richardson, TX (US)

(72) Inventor: Jason Meiners, Richardson, TX (US)

(21) Appl. No.: 13/948,676

(22) Filed: Jul. 23, 2013

(51) Int. Cl. H04N 5/268

(52) U.S. Cl. CPC H04N 5/268
USPC 348/705

(57) ABSTRACT

A method for controlling a network capable AV switching device 32 using a Zero Configuration Network protocol is claimed. The method uses a user created configuration data table 51 to create a plurality of virtual channels or devices 36 representing desired output states of the AV switching device 32. These virtual channels 36 are published to the network via a Zero Configuration Network protocol, such as Bonjour or UPnP. Each of these virtual channels 36 has a corresponding switching command list 54 for the AV switching device 32 that will be automatically activated when a connection to that virtual channel 36 is made. This allows the user to efficiently and simply control the operation of the AV switching device 32 through a single selection of one of the virtual channels 36.

### CROSS-REFERENCE TO RELATED APPLICATIONS

This application claims the benefit of PPA EFS ID 13875416 (application No. 61/708,023) filed 30 Sep. 2012 by the present inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of consumer electronics. More particularly, the present invention is in the technical field of network connected audio video (AV) switching devices.

When network audio and video source connections are added to audio video switching devices, consideration must be made for how this new functionality will be controlled by the end user.

A Zero Configuration Networking is a set of techniques that can create a network connection between devices without user or host intervention. It has several popular implementations in the AV industry, such as Apple's Bonjour and DNLAs UPnP (universal plug and play). These protocols allow a device on the network to “publish” a service, such as audio playback, which includes all of the device configuration data required for another device to connect to it. The selection of which device to connect to is made by the user at the streaming source device, such as an iPhone.

AV switching devices are controlled through a command stream interface. The physical implementation of this command stream varies (typically RS232, IR, or TCP), but the data exchanged is very consistent across devices. The AV switching devices will receive command packets that explicitly describe a switch connection to be made. For example, a command packet may request “connect output audio 1 to input audio 7”. This command stream can be generated by many different types of control devices.

Existing solutions use these separate mechanisms for controlling the network AV connection and the switching of signals inside the matrix device. This yields a complex, multiple step control flow process the user must navigate to perform his desired operation.

An example of prior art is shown in FIGS. 1 and 2. FIG. 1 shows an existing system mapped as follows. Component 11 is a discrete network audio receiver, in this case one or more Apple Airport Express device. Component 12 is a standalone audio and video matrix switch (many different models available). Component 13 are standard televisions. Component 14 are standard speakers. Component 15 are typical physically connected AV devices such as DVD players or Cable boxes.

FIG. 2 illustrates the control flow diagram for the prior art system in FIG. 1 representing the steps to create an AV data stream connection from a network AV source to one or more of the video and/or audio playback devices. Step 21 is the user decision on desired result. In this example, it is for the user to stream audio from his network audio source, in this case an iPhone, to speakers in room X. Steps 22, 23, 25, 26, and 27 are all user actions. Step 22 is an iterative process where the user must find a free network AV receiver 11. This is done by selecting each network AV receiver 11 until they find one which accepts the connection (busy receivers will refuse new connection attempts). Once the user has made a successful connection, they must remember which network AV receiver 11 they connected, variable B in the flow chart. Step 23 is the user starting the audio stream to the connected network AV receiver 11. Step 24 is completed by the network AV receiver 11. It decodes the AV data stream and presents it to the AV switching device 12 on input A+B. Step 25 is the user switching from his network audio source, the iPhone, to a different remote control for the AV switching device 12. Step 26 is the user calculating the actual input number as A+B (A is the first input used by the network audio receivers 11, B is the offset the user found in step 22). Step 27 is the user issuing the command to the AV switching device 12 to connect output X to input A+B. If the user wanted to connect to multiple outputs, they could issue more commands here to do so. Step 27 is the desired end state of an active AV data stream connection from the network AV device to the audio playback device in room X.

### SUMMARY OF THE INVENTION

The present invention is a method for controlling a network capable AV switching device using a Zero Configuration Network protocol.

### BRIEF DESCRIPTION OF THE DRAWINGS

FIG. 1 is a block diagram of prior art.

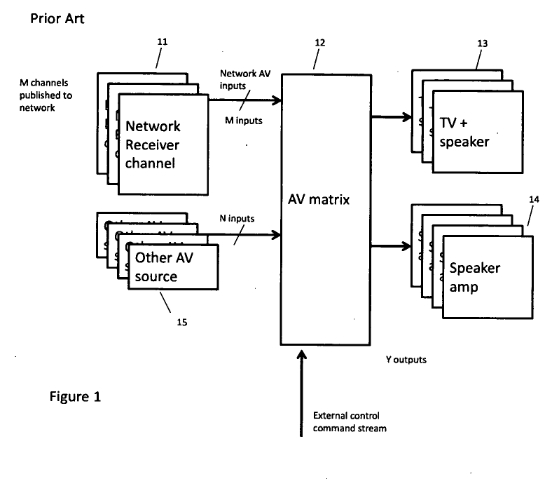

FIG. 2 is the control flow chart of prior art.

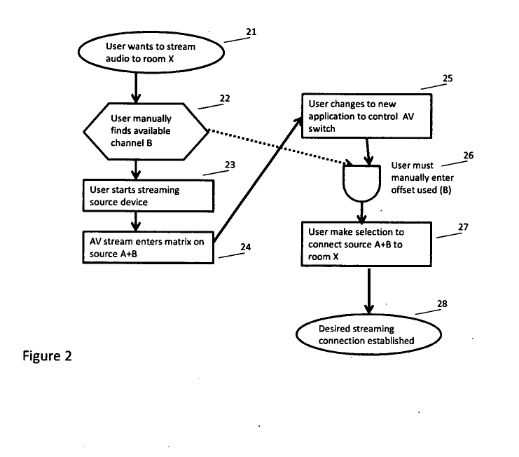

FIG. 3 is the block diagram of Embodiment 1.

FIG. 4 is the control flow chart of Embodiment 1.

FIG. 5 is an example of virtual channel meta-data.

### DETAILED DESCRIPTION OF THE INVENTION

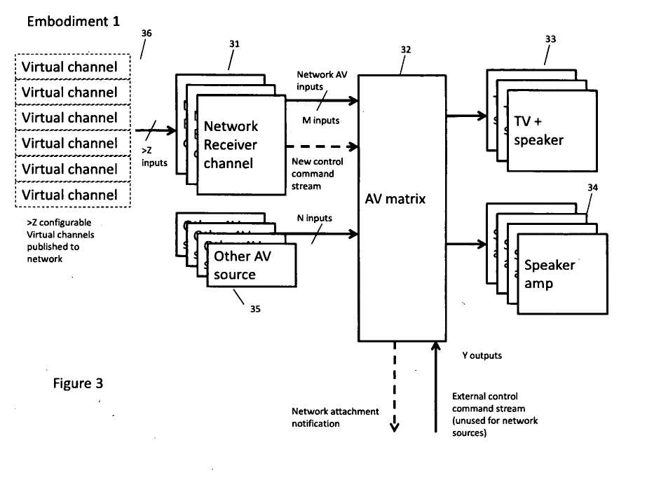

Referring now to Embodiment 1 of the invention, in FIG. 3 there is shown an audio video switching device 32 which is connected to one or more network AV receivers 31. The audio video switching device 32 is also connected to one or more non-network AV sources 35, one or more video and audio display/playback devices 33, and one or more audio playback devices 34. All of components 31 through 35 are physical hardware. Component 36 shows the virtual channels 36 that are connected to the audio video network receivers 31 and also published to the network via the Zero Configuration Networking protocol.

In more detail, still referring to Embodiment 1 of the invention in FIG. 3 we will describe how the components of the system function. The non-networked AV sources 35 are devices which provide audio and/or video through a direct cable connection, such as a DVD player or a Cable box. The non-networked AV sources provide direct inputs to the AV switching device 32. They are shown in the context of this Embodiment to illustrate that the AV switching device 32 has the requirement to switch both networked and non-networked sources. The video and audio display/playback devices 33 and the audio playback devices 34 are all connected to the outputs of the AV switching device 32. They are the end points for any desired AV connection through the system. The AV switching device 32 is an electronic crossbar switch that can make connections from any source to any output. It can also send a single source to multiple outputs simultaneously. The network AV receivers 31 are connected to a IP network, either through a wired or wireless connection, and also provide their outputs as sources to the AV switching device 32. The network AV receivers 31 generate and publish the virtual channels 36 to the network via the Zero Configuration Networking protocol. All of the network AV receivers 31 are managed by a single software control thread running on one of the network AV receiver 31 devices. All the components in this Embodiment may be integrated in a single device or be partitioned into separate physical devices.

In further detail, still referring to Embodiment 1 of the invention in FIG. 3, the network AV data stream flow through the system is a follows. The data flow starts at the network AV device (not shown), connects to one of the virtual channels 36, through one of the network AV receivers 31, into the AV switching device 32, and out to one of the video and audio display/playback devices 33 or audio playback devices 34. For control, the network AV receiver 31 will send a command stream to the AV switching device 32 based on the users virtual channel selection and the automatically mapped network AV receiver 31 instance. The AV switching device will forward this command stream as a notification to any host (not shown) connected to its original command stream interface. This notification is for synchronization of switch state purposes.

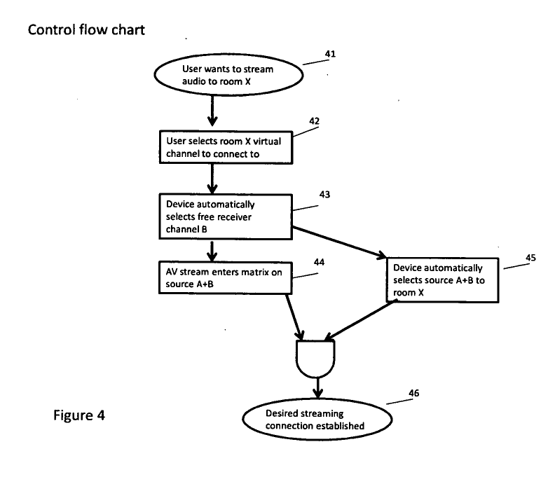

Referring now to Embodiment 1 of the invention, in FIG. 4 there is shown a control flow diagram representing the steps to create an AV data stream connection from a network AV source to one or more of the video and/or audio playback devices. Step 41 is the user decision on desired result. In this example, it is for the user to stream audio from his network audio source to speakers in room X. Step 42 is a user action. The user starts his audio and selects the virtual channel target for room X. The remaining steps 43 through 46 are all device actions without user intervention. Step 43 is the network AV receiver receives the connection through virtual channel X. The control thread running on the network AV receiver then selects a free receiver channel, labeled B, to decode the network audio stream. Step 44 is the decoded AV data stream being sent from network AV receiver B to the AV switching device on input A+B. In step 45, the network AV receiver will send a command stream to the AV switching device instructing it to connect output X to input A+B. When both steps 44 and 45 are complete, step 46 will be entered. Step 46 is the desired end state of an active AV data stream connection from the network AV device to the audio playback device in room X.

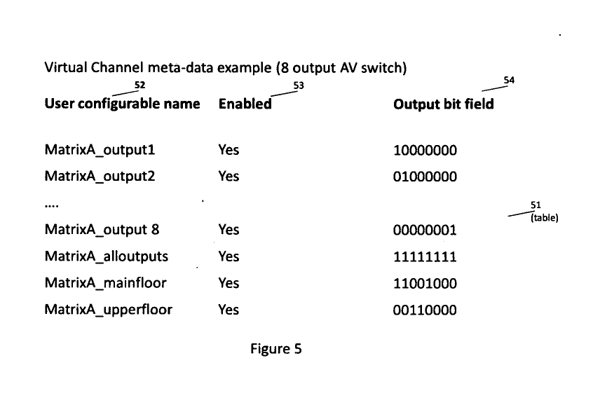

Referring now to Embodiment 1 of the invention, in FIG. 5 there is a table which gives an example of the configuration data 51 for creation of the virtual channels 36. In this example we are assuming that the AV switching device has eight outputs. The first field of the table is the user configurable name 52 for the virtual channel. The second field of the table 52 is a Boolean variable indicating if this channel is enabled and will be published. The third field of the table is the output control bit field 54. This bit field 54 has one bit for each output on the AV switching device. A value of 1 indicates that the respective output will be connected if this virtual channel is selected. For example, for the row with user configurable name MatrixA_upperfloor, the output control bit field 54 is 00110000. This translates to “connect source to output 3 and output 4” when this virtual channel 36 is selected.

In more detail, still referring to Embodiment 1 of the invention in FIG. 5 we will describe how the user will setup the configuration data 51. First, the user should decide how many virtual channels 36 they need. This will be equal to the number of connection options they plan to use. For example, in the FIG. 5 we should allocate one virtual channel 36 for each output zone plus one virtual channel 36 for all zones and two virtual channels 36 for building floors. The device does not limit the number of virtual channels 36. The user may have as many as they deem useful. Next, the user should name each virtual channel 36 to something unique and meaningful for their application. For example, if output 1 goes to the bedroom speakers it may be named “Master_bed_speakers”. The enable field 53 is then set to “Yes” for all virtual channels 36 the user wants to use. “No” can be used to disable virtual channels 36. The output control bit field 54 is then setup for each virtual channel 36. In the “Master_bed_speakers” example, they would want to set bit position 1 to 1 and all other bits to 0. This would provide a connection only to output 1 when selected. Once all the virtual channels 36 are configured, this configuration data 51 is saved and does not need to be edited again.

In further detail, still referring to Embodiment 1 of the invention in FIG. 5 we will describe how the network AV receiver 31 control thread will use the configuration data 51 to create the virtual channels 36. For each virtual channel 36 defined in the configuration data 51, the network AV receiver 31 will publish the user configurable name 52 of the virtual channel 36 via the Zero Configuration Networking protocol. It is noted that these protocols provide additional data not discussed here, such as IP address, device capabilities, port number, channel identifier, etc. The network AV receiver 31 will also provide this data as required by the protocol. When a data connection is made to one of the published virtual channels 36, the network AV receiver 31 will first follow the Zero Configuration Networking protocol to establish the connection data pipe. Once established, the network AV receiver 31 will use the channel identifier to look up the output control bit field 54 for that channel. For each “1” in the output control bit field 54, the network AV receiver 31 will send a command to the AV switching device 32 to connect that output to the input corresponding to the decoded AV data stream. Once all bits are processed, the operation is complete.

The advantages of the present invention include, without limitation, a simplified and improved user experience when using a network AV device. In prior art, the user had to access and make selections in two different control applications or devices. They also had to manually transfer data between these different application or devices. The invention allows the same desired end result to be achieved with only a single selection directly on the network AV device. It also does not require any new software or programming on the network AV device since the underlying Zero Configuration Protocol is unchanged. It is a simple and elegant solution to the complex problem of integrating network AV stream control with existing non network AV stream control.

While the foregoing written description of the invention enables one of ordinary skill to make and use what is considered presently to be the best mode thereof, those of ordinary skill will understand and appreciate the existence of variations, combinations, and equivalents of the specific Embodiment, method, and examples herein. The invention should therefore not be limited by the above described Embodiment, method, and examples, but by all Embodiments and methods within the scope and spirit of the invention.

I claim:

1. A method for controlling an audio and/or video switching device using virtual channels published via a Zero Configuration Networking protocol, comprising:
a. providing an audio and/or video switching device with multiple inputs and outputs and one or more command stream control interfaces
b. providing one or more network audio and/or video receiver devices or sub devices capable of executing a Zero Configuration Networking Protocol
c. providing one or more network audio and/or video source devices capable of executing a Zero Configuration Networking Protocol
d. providing a user defined configuration data table indicating the virtual channel to output selection control parameters
e. causing the audio and/or video switching device to automatically make the desired input to output connections indicated by the users virtual channel selection.
